(19) United States
(12) Patent Application Publication
(10) Pub. No.: US 2010/0294893 A1
(43) Pub. Date: Nov. 25, 2010

(54) AERODYNAMIC COMPONENT WITH A DEFORMABLE OUTER SHELL

(75) Inventors: Olaf HEINTZE, Cremlingen (DE); Hans Peter MONNER, Meine (DE); Markus KINTSCHER, Braunschweig (DE); Johannes RIEMENSCHNEIDER, Braunschweig (DE); Thomas LORKOWSKI, Taufkirchen (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DEUTSCHES ZENTRUM FÜR LUFT- UND RAUMFAHRT E.V., Koln (DE)

(21) Appl. No.: 12/785,785

(22) Filed: May 24, 2010

(30) Foreign Application Priority Data
May 25, 2009 (DE) 10 2009 026 457.4

(51) Int. Cl. B64C 3/44

(52) U.S. Cl. 244/219

(57) ABSTRACT

The invention relates to an aerodynamic component, in particular a wing, a landing flap, a pitch elevator, a yaw rudder, a fin or tail. The aerodynamic component comprises an outer shell and at least one supporting element supporting said outer shell. A drive unit rotates the supporting element. A supporting region is created between the supporting element and the outer shell. The supporting region transfers deformation forces from the drive unit via the supporting element to the outer shell. The supporting element is designed and configured for changing the distance of the supporting region from a longitudinal plane of the aerodynamic component with a rotation of the supporting element. The outer shell comprises an elastic deformation region. The elastic deformation region is elastically deformed by the deformation forces with a rotation of the supporting element.

### CROSS REFERENCE TO RELATED APPLICATIONS

This application claims priority to co-pending German Patent Application No. DE 10 2009 026 457.4 entitled “Aerodynamisches Bauteil mit verformbarer Auβenhaut”, filed May 25, 2009.

### FIELD OF THE INVENTION

The present invention generally relates to an aerodynamic component for a flying object, in particular a wing, a starting or landing flap, a pitch elevator, a yaw rudder, a fin or a vertical or horizontal tail.

### BACKGROUND OF THE INVENTION

In particular during the starting or landing process of a flying object, it is desired to influence the aerodynamic behavior of an aerodynamic component by changing the cross-section of the component or the contour of the outer shell of the component. It is known to lower a leading edge of a wing or flap during the landing or starting process in order to increase the ascending force or change the aerodynamic resistance. In general, this is done by using movable or pivotable front flaps or landing flaps. These flaps are moved or pivoted by complex drive mechanisms comprising links, levers, pushing or pulling rods and the like. One disadvantage of movable or pivotable flaps involves slots built in the outer contour between the movable or pivotable parts. These slots influence the boundary layer of the airstream floating around the aerodynamic component. On the other hand, an airstream floating through a slot might also be used for accelerating an airstream at the upper side of a wing or flap, wherein the airstream might be used both for increasing the ascending force and avoiding or delaying stall. As a disadvantage, the airflow streaming through a slot causes noise during the starting or landing process, which contributes a significant part of the overall noise caused by the flying object. Hence, for keeping the noise levels low during the starting and landing process, the increased curvature necessary for the ascending forces resulting in an increased circulation of air around the aerodynamic component should be produced without any slots in the outer contour. Another disadvantage of slots and edges is that in the neighborhood of the slots and edges, a laminar flow changes to a turbulent flow, which leads to a significant increase of the resistance along with increased fuel consumption and increased emissions of the flying object.

The airplane Airbus A 380 uses a nose which is pivoted relative to a main wing. The nose is pivoted around a longitudinal axis of the aerodynamic component. During this pivoting movement, the nose is pivoted as a rigid body.

A so-called “Horn Concept” uses horn-like shaped structures or rods as an eccentric drive of landing flaps having a variable shape; see the following documents:
J. N. Kudva, “Overview of the DARPA Smart Fixed Wing Project”, Journal of Intelligent Material Systems and Structures, 15(4), 2004;
Dietmar Müller, “Das Hornkonzept—Realisierung eines formvariablen Tragflügel-profils zur aerodynamischen Leistungsoptimierung zukünftiger Verkehrsflugzeuge”, Dissertation an der Fakultät Luft- and Raumfahrttechnik der Universität Stuttgart, 2000;
S. C. Roberts, D. Stewart, V. Boaz, G. Bryant, L. Mertaugh, G. Wells, M. Gaddis, “XV-11A Description and Preliminary Flight Test”, Aerophysics Research Report No. 75, USAAVLABS Technical Report 67-21, 1967;
U.S. Pat. No. 4,286,671.

US Patent Application Nos. US 2007/0241236 A1 and US 2009/0272853 A1, U.S. Pat. No. 7,530,533 B2, U.S. Pat. No. 4,650,140 A, U.S. Pat. No. 4,553,722 A, U.S. Pat. No. 4,475,702 A1, U.S. Pat. No. 4,706,913 A1, U.S. Pat. No. 6,796,534 B2, U.S. Pat. No. 4,351,502 A1, U.S. Pat. No. 4,200,253 A, U.S. Pat. No. 6,076,776 A, U.S. Pat. No. 6,010,098 A, U.S. Pat. No. 4,252,287 A as well as United Kingdom Patent Application No. GB 2186849 A relate to so called “Droop Nose Concepts”. A selectively deformable outer shell is in particular disclosed in US Patent Application Nos. US 2006/0163431 A1, US 2006/0145031 A1 and US 2005/151015 A1.

Drive mechanisms for moving flaps in general extend through recesses or bores of frontspars or rearspars of the aerodynamic component. The recesses require enforcements and ceilings due to the fact that the spars are used as supporting elements of the aerodynamic component and might also be used as supporting or limiting element for a tank.

### OBJECT OF THE INVENTION

It is an object of the present invention to provide an aerodynamic component comprising a deformable outer shell.

Another object of the present invention is to provide a modified drive unit.

Another object of the present invention is to provide a reliable support of the outer shell of the aerodynamic component.

Furthermore, an object of the present invention might be to guarantee a desired contour of a changeable or adaptable cross-section of the aerodynamic component or the outer shell.

### SUMMARY OF THE INVENTION

The present invention relates to any aerodynamic component, in particular a wing, a landing or starting flap, a pitch elevator, a yaw rudder, a fin or a vertical or horizontal tail. According to the invention, the contour of the aerodynamic component is changed or adapted for changing or influencing the aerodynamics of the aerodynamic component. The aerodynamic component according to the invention comprises a deformable outer shell. The deformation in particular is a repeatable plastic or elastic deformation. The outer shell may have any design. For one embodiment, the outer shell may be built with one single layer or a plurality of layers of the same or differing thickness. However, the outer shell may also be constructed from a composite material or an outer shell supported with inner struts or rods and the like. The outer shell is supported by supporting elements. These supporting elements both preserve the outer shape of the outer shell and increase the load capacity of the outer shell under static and dynamic, and, in particular, aerodynamic loads. At least one supporting element is responsible for transferring deformation forces to the outer shell causing a deformation of the same. Accordingly, the supporting elements may be multifunctional by keeping the outer shell in an original cross-section or contour or a deformed cross-section or contour and also being used for causing a change of the cross-section or contour by causing a deformation of the outer shell.

According to the invention, a drive unit is provided for rotating the supporting element. The drive unit may be of any type, e.g., a hydraulic or electrical drive. The drive unit might also include a transfer mechanism or transmission, such as a hydraulic or mechanical transmission.

The outer shell and the supporting element interact with each other in a supporting region. By means of a rotational movement of the supporting element, the distance of the supporting region from a longitudinal plane of the aerodynamic component is changed. The supporting region may be a local link or contact point between the outer shell and the supporting element or may be a more global link or contact area. The supporting region may have some extension along a longitudinal axis of the component as well as in the direction of the airstream around the aerodynamic component.

The change of the distance of the supporting region correlates or corresponds to the extent of the deformation of the outer shell at the supporting region. The rotation of the supporting element causes a deformation force that is responsible for the deformation of the outer shell. The deformation force may counteract an elastic pretension that presses the outer shell against the supporting element. The force flow starting at the drive unit is transferred by the rotatable supporting element via the supporting region to the deformable outer shell. In contrast to the cited background art, the inventive design does not necessarily require additional mechanics as levers, struts, links and the like between the supporting element and the outer shell. For example, it may be sufficient to keep the supporting element and the outer shell in loose or sliding contact. For these embodiments, the supporting element is directly supported at the outer shell.

In one embodiment of the invention, the axis of rotation of the supporting element has an orientation along or parallel to the longitudinal axis of the aerodynamic component. A plurality of drive units each associated with one or a plurality of supporting elements may be located at a plurality of positions along the longitudinal axis of the aerodynamic component with same or differing distances.

In another embodiment of the invention, the axis of rotation of the supporting element has an orientation parallel to the incoming airstream or parallel to the flight direction of the flying object or the aerodynamic component or transverse to the longitudinal axis of the aerodynamic component. For this embodiment, the supporting element is effective in a partial longitudinal region of the aerodynamic component. In case of a coaxial arrangement of the supporting element and the drive unit, the given extension of the aerodynamic component in the incoming flow is exploited for housing the supporting element and the drive unit. In case of the aerodynamic component or wing increasing in thickness from the between the leading or trailing edge, the increased distance between the upper and lower outer shell may be used for housing the drive unit.

Another embodiment of the invention is in the following called “first variant”. For this first variant, for a rotation of the supporting element, the supporting region is moved along the outer shell. The contact or linking point relocates or migrates along the outer shell. This movement coincides with a change of the distance of the supporting region from the longitudinal axis or longitudinal plane of the aerodynamic component. Accordingly, this movement coincides with a deformation of the outer shell.

Another embodiment of the invention is in the following called a “second variant”. For this embodiment, the supporting element comprises a curved outer surface. This outer surface creates a type of rolling contact with the outer shell such that, with a rotation of the supporting element, the supporting region moves along the outer surface of the supporting element.

The present invention also covers an embodiment, wherein a supporting region of the supporting element is only formed in the transfer region between the supporting element and an upper outer shell located on top of the aerodynamic component (or a lower outer shell located at the bottom of the aerodynamic component). For this embodiment, the supporting element only influences the contour of the upper surface (or lower surface) of the aerodynamic component. It is possible that the other side of the aerodynamic component is not influenced at all. However, it is also possible that the contour of the other side of the aerodynamic component is changed in other measures. For another embodiment leading to a very compact design, one and the same supporting element forms both a supporting region with the upper outer shell of the aerodynamic component as well as a supporting region with the lower outer shell of the aerodynamic component. For this embodiment, a rotation of one and the same supporting element causes both a deformation of the upper and lower outer shell. The caused deformations of the upper and lower outer shell may, for example, be predetermined by the shape of the outer surface of the supporting element. For this embodiment, the deformations of the upper and lower outer shell have an exact correlation guaranteed by the shape of the outer surface of the supporting element.

The invention also suggests that the outer surface of the supporting element, which is used for forming the supporting region, only partially extends in circumferential direction around the axis of rotation of the supporting element. For another embodiment of the invention, the outer surface of the supporting element extends along the entire circumference around the axis of rotation. For this embodiment, the outer surface has a type of ring structure. This is of advantage with respect to the mechanical stiffness of the supporting element and the outer surface for transferring the deformation forces. Furthermore, a rotation of up to 360° may be used for pivoting the supporting element, wherein the supporting region moves along the entire circumference of the outer surface. For such movement, the drive unit might rotate the supporting element in forward and backward movement or might drive the supporting element only in one direction with an angle of rotation of more than 360°.

In case of the supporting element or the outer surface of the same having only a small extension in the direction of the incoming airstream, the supporting element with its rotation only transfers local deformation forces to the outer shell. For another embodiment of the invention, the outer surface of the supporting element has an extension in the direction of the rotational axis such that the outer shell contacts the supporting element in the supporting region with an increased extension in this direction. In this way, the support between the supporting element and the outer shell in the direction of the incoming airstream or the airstream floating around the aerodynamic component may be improved.

In another embodiment, the outer surface of the supporting element comprises a contour in the direction of the rotational axis that correlates with the contour of the upper and/or lower outer surface of the aerodynamic component in this direction. For a simple example, in case of the outer shell having a constant thickness, the contour of the supporting element exactly corresponds to the contour of the upper surface and/or lower surface of the aerodynamic component. In order to cause the desired effect of a deformation of the outer shell, the outer surface of the supporting element in a cross-section taken transverse to a rotational axis comprises an outer contour differing from a circular contour. In particular, this contour is cam-shaped. Such a cam-like contour may comprise one or a plurality of maxima and minima. During a rolling movement of the cam-shaped supporting element at the outer shell, the maxima push the outer shell away from the axis of rotation, whereas, in the region of the minima, the supporting elements pull the outer shell back towards the axis of rotation. The elasticity of the outer shell and/or of other supporting elements may be responsible for the movement of the outer shell back towards the axis of rotation when reaching the minima.

In another embodiment of the invention, a plurality of rotatable supporting elements is provided. The supporting elements are positioned along the longitudinal axis of the aerodynamic component. Each rotatable supporting element may be driven by a respective separate drive unit. It is also possible to drive a group or all of the supporting elements by one single drive unit, wherein the supporting elements may also be linked with this drive unit by differing transmission units for changing the angles of rotation or for redirecting the drive axes. In one example of this embodiment, a drive shaft having an orientation along the longitudinal axis of the aerodynamic component, such as a hollow drive shaft, comprises crown gears interacting with crown gears linked with respective supporting elements. A variation of the angle of rotation of the supporting elements may be caused by using crown gears of differing diameters and/or number of teeth. To mention another example, a toothed rack having an orientation in longitudinal direction of the aerodynamic component may be driven in a longitudinal direction by one single drive unit and may mesh with gears associated with respective supporting elements.

The distance of adjacent supporting elements may be chosen such that in the intervals between the supporting elements, the load resistance of the outer shell is given without the use of additional supporting elements. In these embodiments, the mechanical stiffness of the outer shell guarantees a predetermined contour between the supporting elements. However, it is also possible that further supporting elements are located in the intervals between adjacent rotatable supporting elements. These additional supporting elements might be pendulum struts or struts or rods that might be linked in one end region with the upper outer layer and in the other end region with the lower outer shell or in one end region with a spar. These additional supporting elements may also be deformed with the pivoting movement of the supporting elements.

The outer shell may be of any known type. According to one embodiment of the invention, the outer shell is constructed with an outer layer supported by inner stringers, in particular omega-stringers. Such design has proven to result in an outer shell with a good load resistance but a small overall weight. For this embodiment, the supporting region might be formed by a contact area between the stringers and the supporting element. A deformation force caused by the supporting element is transferred to the outer layer via the stringers, wherein the stringers guarantee a transfer of the deformation force in the increased contact surface between the stringer and the outer shell. This improved force transfer leads to decreased local stresses acting upon the outer layer.

For a very compact design, the invention suggests to house the drive unit and/or at least one supporting element in a chamber or space formed between a frontspar and a leading edge or a rearspar and a trailing edge of the aerodynamic component. For this embodiment, it is possible to assemble the drive unit with the frontspar or rearspar using the mechanical stiffness of the spar for holding the drive unit.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a three-dimensional schematic view of an aerodynamic component, here a part of a wing of a flying object.

FIG. 2 is a vertical longitudinal section of an aerodynamic component in a first variant.

FIG. 3 is a vertical longitudinal section of an aerodynamic component in a second variant.

FIG. 4 is a three-dimensional schematic view of an aerodynamic component comprising a plurality of rotatable supporting elements located distant along the longitudinal axis.

FIG. 5 shows in a plan view of supporting elements mounted with a frontspar, the supporting elements comprising a longitudinal axis curved or slanted with respect to the axis of rotation, here for an angle of rotation of the supporting elements for a configuration and contour used during normal flight.

FIG. 6 shows the elements of FIG. 5 for an angle of rotation of the supporting elements for a configuration and contour used during the starting or landing process.

FIG. 7 shows a rotatable supporting element mounted with a frontspar in a transverse cross-section in a configuration used during normal flight.

FIG. 8 shows the supporting element of FIG. 7 in a transverse cross-section in a configuration used during the starting or landing process.

FIG. 9 shows a transverse cross-section of an aerodynamic component with additional supporting elements in an interval between adjacent rotatable supporting elements, the outer shell constructed with an outer layer and omega-stringers and the additional supporting element of the type of pendulum rods for the aerodynamic component in a configuration used during normal flight.

FIG. 10 shows the aerodynamic component of FIG. 9 in a configuration used during the starting or landing process.

### DETAILED DESCRIPTION

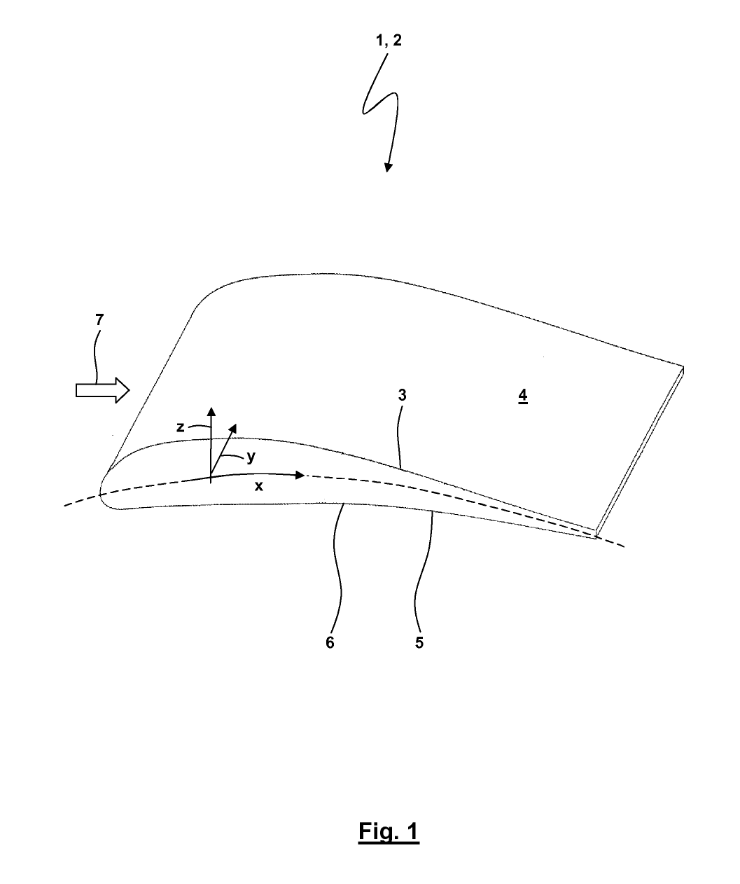

Referring now in greater detail to the drawings, FIG. 1 illustrates an aerodynamic component 1, here embodied as a wing 2 of a flying object or airplane. This example should not restrict the invention to this type of aerodynamic component. The invention may be used for changing the airflow around an aerodynamic component of any type by changing the contour of the aerodynamic component. To name only a few examples, the aerodynamic component might be a wing, a starting or landing flap, a pitch elevator, a yaw rudder, a fin or a vertical or horizontal tail and the like.

In the specification, the following system of axes is used for describing the orientations and geometries: The axis y is used for the longitudinal axis of the wing 2, whereas the axis x denotes a transverse axis along which the contour 3 of an upper surface 4 of the wing 2 as well as a contour 5 of a lower surface 6 of the wing 2 changes. A longitudinal plane is defined by the coordinates x, y. In case of the dynamic component 1 being a wing 2, the longitudinal plane for horizontal flight condition has an approximately horizontal orientation. The axis z denotes the extension of the wing in the direction of the thickness, so that the contours 3, 5 may be described by functions z₃(x)=f₃(x) and z₅(x)=f₅(x). A vertical longitudinal section is a section through the wing 2 taken in a plane parallel to the plane y-z, whereas a (transverse) cross-section is a cross-section taken parallel to the plane x-z. A person with skill in the art is aware of the fact that for aerodynamic components differing from a wing 2 as shown in FIG. 1, a coordinate transformation might be necessary. For the example of a fin or vertical tail, this means that the axis y of the component 1 has an orientation in vertical direction. In FIG. 1, the incoming airstream 7 is denoted with reference numeral 7. In the optimal case, the incoming airstream results in a laminar flow of the air along the contours 3, 5 at the upper surface 4 and the lower surface 6. The incoming airstream 7, in the easiest case for horizontal flight conditions, has an orientation approximately parallel or coaxial to the transverse axis x. Depending on the flight conditions of the aerodynamic component 1, e.g., during ascending or descending flight, during the landing process or starting process or during flight in a curve an acute angle may also be established between the direction of the incoming airstream 7 and the transverse axis x.

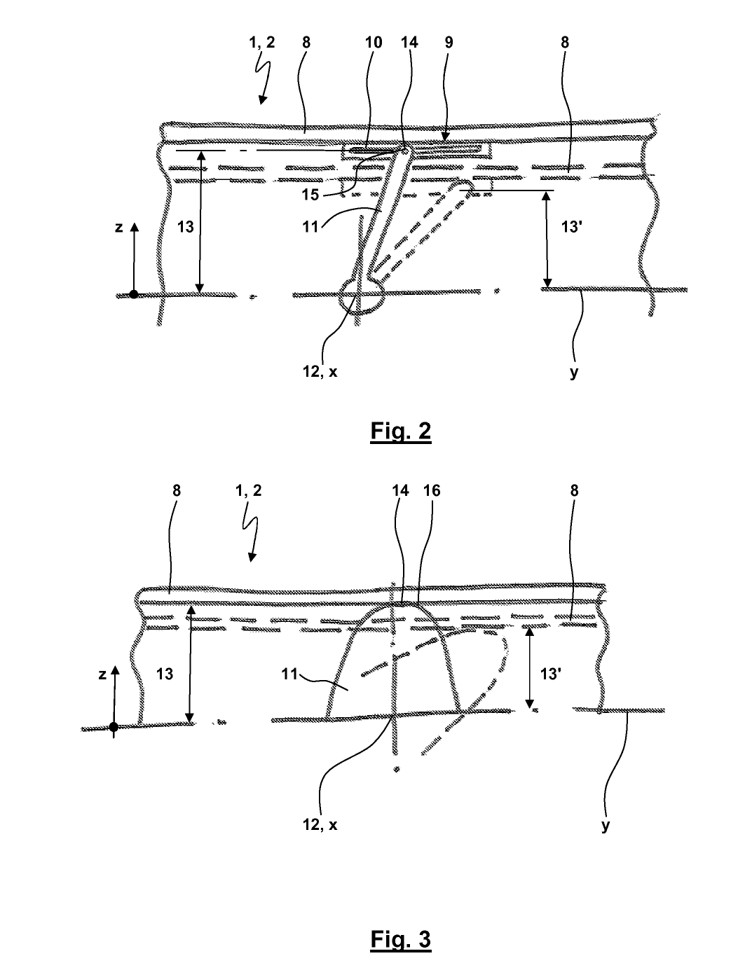

FIG. 2 shows an inventive wing 2 according to a “first variant” of the invention in a longitudinal cross-section. The wing 2 is constructed with an outer shell 8 forming the upper surface 4 of the wing 2. At an inner surface, a guiding unit 9 is fixed at the outer shell. For the shown embodiment, the guiding unit 9 is formed by means of a guidance comprising an elongated slot 10. The guiding unit 9 cooperates with a supporting element 11 such that a rotation of the supporting element 11 around the axis of rotation 12 a distance 13 of a supporting region 14 established between the supporting element 11 and the outer shell 8 from the longitudinal plane x-y changes to a decreased distance 13′. The axis of rotation 12 has an orientation perpendicular to the longitudinal axis y and to the drawing plane according to FIG. 2. The axis of rotation 12 is approximately coaxial with the transverse axis x. For the embodiment shown in FIG. 2, the supporting region is formed by a contact region or a region of interaction between the guiding unit 9 and the supporting element 11. Here, the interaction is embodied in a guiding pin 15 protruding from the supporting element with an orientation parallel to the axis of rotation 12 engaging the elongated slot 10 of the guiding unit 9. The guiding pin 15 has a degree of freedom for a sliding movement along the elongated slot 10 parallel to the longitudinal axis y. For one embodiment, the guiding unit 9 and the supporting element 11 with guiding pin 15 may be seen as a type of crank drive. For the shown embodiment, the angle of rotation of the supporting element 11 may be limited in the maximum between a 12 o'clock position and a 3 o'clock position (or 9 o'clock position), whereas in particular smaller angles of rotation are used. In the starting position shown in FIG. 2, the outer shell 8 is shown with solid lines. A changed contour 3 of the outer shell resulting from a rotation of the supporting element 11 in a 2 o'clock position is shown with dashed lines. The same type of drive may be used for changing the contour 5 at the lower surface 6 of the wing 2. For a change of the contour 5, the same supporting element 11 shown in FIG. 2 may be used or a separate, additional supporting element 11. The supporting element 11 may be equipped with an integral additional arm extending from the axis of rotation 12 in FIG. 2 downward and interacting with the outer shell 8 at the lower surface 6 of the wing. For the shown embodiment, the guiding unit 9 with the engagement of the guiding pin 15 in elongated slot 10 may transfer both a deformation force directed in upward and downward direction to the outer shell 8. Any other type of supporting region 14 established between supporting element 11 and outer shell 8 may also be used. It may also be sufficient to create a simple sliding contact between the supporting element 11 and the outer shell 8 transferring forces only by a normal force in one direction, i.e., a deformation force applied upon the outer shell 8 in outer direction. The contact force between the outer shell 8 and the supporting element 11 may be caused by an elastic pretension of the outer shell 8 and/or by the airflow streaming along the wing 2 and applying forces upon the outer shell 8 directed towards the supporting element 11. The “supporting region” 14 may be a local contact point without any relevant contact area. However, the “supporting region” may also be a smaller or larger supporting area which is in particular dimensioned such that the admissible stresses caused during the flight of the flying object and caused when deforming the contours 3, 5 are not exceeded. Furthermore, it is possible that the supporting region 14 comprises an extension parallel to the axis of rotation 12. Furthermore, it is possible that the supporting region 14 comprises a varying distance from the axis of rotation 12 in a transverse cross-section.

FIG. 3 shows another embodiment of the invention also named as a “second variant”. Whereas according to FIG. 2 the supporting element 11 involves a type of lever or crank, the embodiment shown in FIG. 3 uses a supporting element 11 comprising a curved outer surface 16 contacting the outer shell 8. With a rotation of the supporting element 11, the supporting region 14 formed by the contact area between the outer surface 16 and the outer shell 8 moves along the outer surface 16 with a sliding or rolling movement between the outer shell 8 and the outer surface 16. The shape of the contour of the outer surface 16 determines the dependence of the change of the distance 13 on the angle of rotation of the supporting element 11 around the axis of rotation 12. Due to the sliding or rolling contact between the outer shell 8 and the supporting element 11, a rotation of the supporting element shifts the supporting region 14 both along the inner surface of the outer shell 8 and the outer surface 16 of the supporting element 11. The outer surface 16 may have an extension vertical to the drawing plane of FIG. 3 such that the supporting region 14 is not only a point contact as shown in the vertical longitudinal section but extends along or parallel to the contour 3 of the outer shell 8. As explained for the embodiment shown in FIG. 2, also for the embodiment shown in FIG. 3 additional supporting elements may cooperate with the lower outer shell 8 at the lower surface 6 (not shown). It is also possible that the outer shell 16 of the supporting element shown in FIG. 3 also extends to the lower outer shell 8 at the lower surface 6 so that with the rotation of one and the same supporting element 11 both a supporting region 14 between supporting element 11 and upper outer shell 8 at the upper surface 4 as well as an additional supporting region established between the supporting element 11 and the lower outer shell at the lower surface 6 change their distances 13 from the longitudinal axis y corresponding to the outer contour of the outer surface 16. Also for this embodiment, the contact force between the supporting element 11 and the outer shell 8 may be caused by the elasticity of the outer shell 8, elastic additional supporting elements or tension elements and/or the airstream along the outer surface of the wing 2.

The supporting element 11 in a first approximation may be seen as a kind of cam. For the shown embodiment, the measures of the invention have been explained and shown when used at the leading edge or nose area of a wing 2. However, the inventive measures may be used at any location along the transverse axis x, such as also in a middle region or close to the trailing edge.

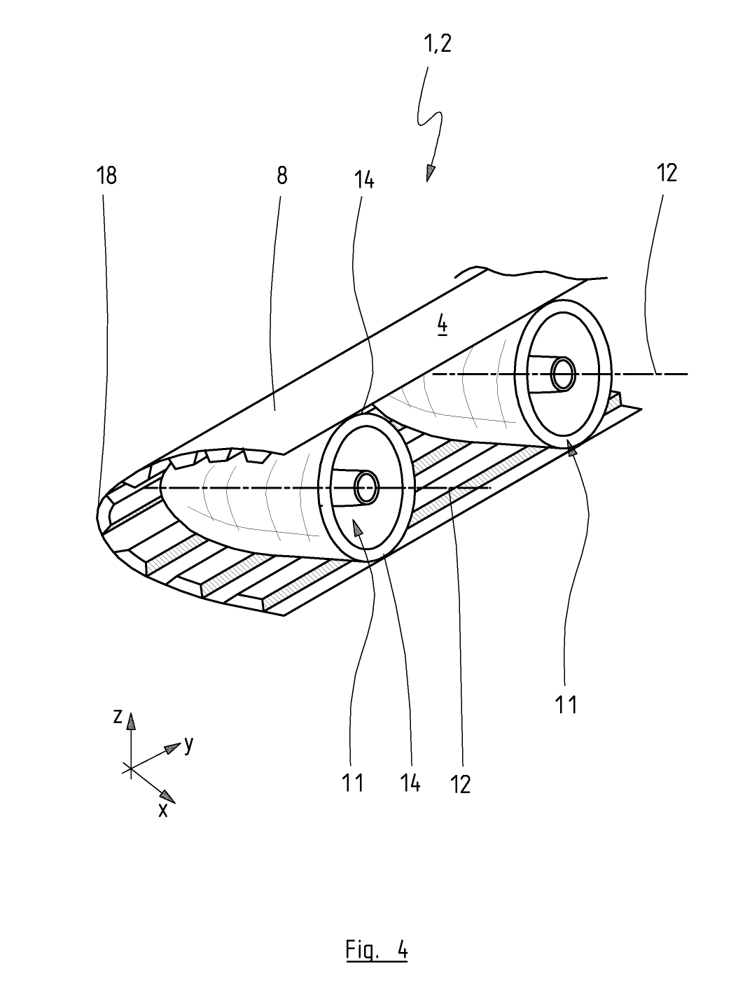

FIG. 4 shows an embodiment of the invention with more constructive details when compared with the schematic representations chosen for FIGS. 2 and 3. Along the longitudinal axis y of wing 2, a plurality of supporting elements 11 is used, here two supporting elements 11. The supporting elements 11 are rotatable around axes of rotation 12 having an orientation transverse to the longitudinal axis y, parallel to each other and approximately coaxial or parallel to the incoming airstream 7. The supporting elements 11 comprise curved longitudinal axes 17 and outer surfaces extending along the entire circumference around the longitudinal axis 17. The distances of the outer surfaces 16 from the longitudinal axes 17 decrease in the direction of the leading edge 18 of wing 2. In one example, the curved longitudinal axis 17 extends in one plane, whereas the outer surface 16 is rotationally symmetric with respect to the curved longitudinal axis 17, e.g., with a parabolic outer contour. However, any other type of contour and orientation of the longitudinal axis may also be used.

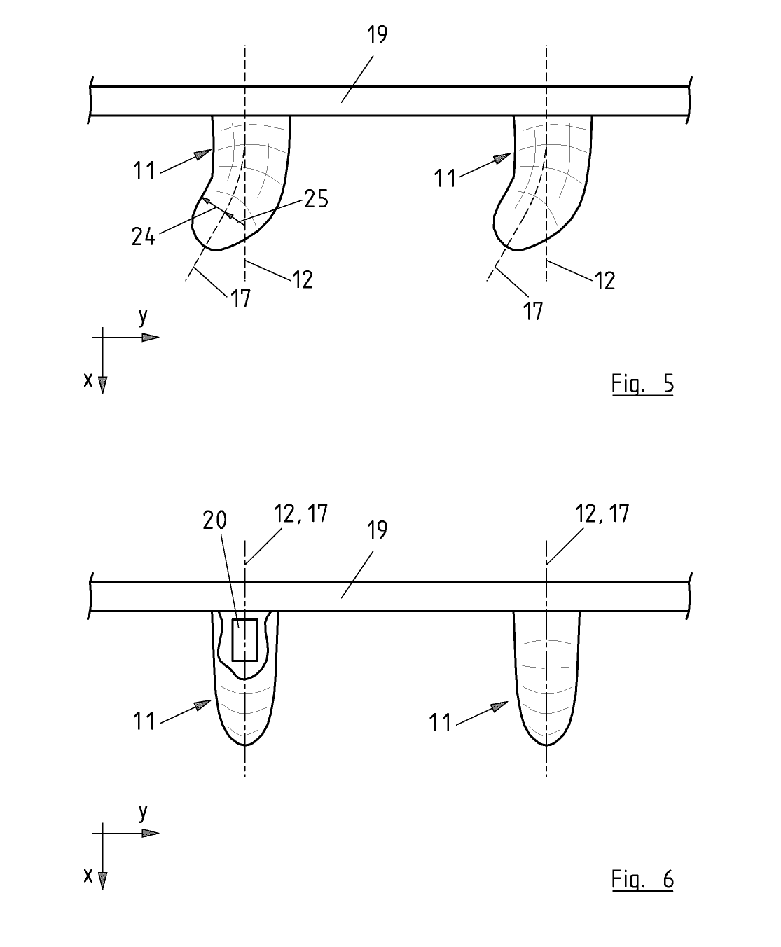

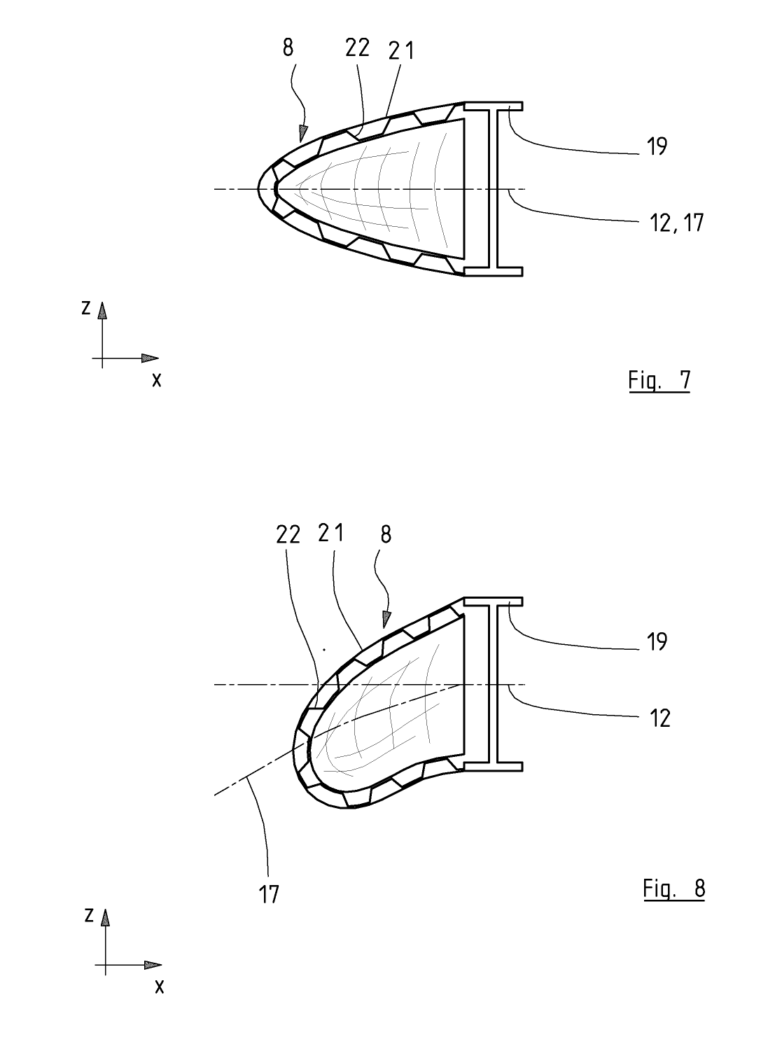

FIGS. 4 and 5 show the wing 2 during normal flight conditions. For these conditions, the curved longitudinal axes 17 extend in a plane parallel to the x-y plane. This orientation of the curved longitudinal axes 17 has the effect that the supporting elements 11 establish supporting regions 14 with the outer shell 8 with distances 13 from the longitudinal plane corresponding to the distances of the outer surfaces 16 of the supporting elements 11 from the curved longitudinal axes 17. Accordingly, the curvature of the longitudinal axes 17 does not have any effect on the distances 13 of the outer shell 8 from the longitudinal plane of the wing 2 for this configuration.

When rotating the supporting element 11 from the configuration shown in FIGS. 4 and 5 into the configuration shown in FIG. 6, the curved longitudinal axes 17 extend in planes creating acute angles to the x-y plane. Due to the curvature of the longitudinal axes 17, the outer shell 8 is pressed in upper or lower direction. This results in a distance 13 of the outer shell 8 from the longitudinal plane of the wing 2 corresponding to the sum of

the distance of the outer surface 16 from the curved longitudinal axis 17 in the supporting region and

the displacement of the longitudinal axis 17 due to the curvature, so the distance of the curved longitudinal axis 17 from the axis of rotation 12.

Due to the fact that the supporting elements 11 shown in FIGS. 4 to 6 comprise a closed outer surface 16 along the entire circumference of the longitudinal axis 17, the supporting elements 11 may establish both a supporting region 14 with the upper outer shell 8 at the upper surface 4 as well as a supporting region 14 of the lower outer shell 8 at the lower surface 6 of the wing 2. A rotation of the supporting element 11 causes a deformation of the outer shell 8 both at the upper surface 4 as well as the lower surface 6 for modifying the contours 3, 5 with one single rotation. In the extreme case, the maximum of the deformation is achieved for rotating the supporting element 11 with an angle of rotation of 90°. This extreme position is shown in FIG. 6 and used for the starting or landing process. Here, the curved longitudinal axis 17 extends in a plane parallel to the x-z plane.

The present invention covers the following embodiments:
a) The longitudinal axis 17 may be straight but the contour of the outer surface 16 may differ from a circle in a cross-section taken in the y-z plane. Accordingly, a deformation of the outer shell 8 with a rotation of the supporting element 11 follows the changing radial distance 24 of the outer surface 16 of the supporting element 11 from the straight longitudinal axis 17 and the axis of rotation 12. Depending on the contour of the noncircular outer surface 16 in the cross-section taken in the y-z plane with a rotation of the supporting element 11, the distance of the contours 3, 5 may be constant or variable.
b) The longitudinal axis 17 may be curved but the outer surface 16 is circular in a cross-section taken in a plane parallel to the y-z-plane. For this embodiment, the deformation of the outer shell 8 with the rotation of the supporting element follows a trigonometric function of the angle of rotation multiplied with the distance 25 of the curved longitudinal axis 17 from the axis of rotation 12. In this embodiment, due to the outer surface 16 with circular cross-section, the distance of the contours 3, 5 does not change with the rotation.
c) A superposition of the above variants a) and b) is also possible with a design of the outer surface 16 with noncircular cross-section and a curved longitudinal axis 17.

As can be seen from FIGS. 5 and 6, the supporting element 11 is located between a leading edge 18 and a frontspar 19. For the shown embodiment, the supporting element 11 is carried and supported by the frontspar 19 and mounted with the same. Furthermore, in the partial section of the supporting element 11 shown in FIG. 6, a drive unit 20 is housed within the hollow supporting element 11 leading to a very compact design. Also the drive unit 20 may be mounted with the frontspar. Also electrical or hydraulic conduits for the drive unit 20 may be supported by the frontspar or may be integrated into the frontspar 19.

For the embodiment shown in FIG. 4, the outer shell 8 is constructed from a composite material created by an outer layer 21 forming the contours 3, 5 as well as the upper surface 4 and the lower surface 6. The outer layer 21 is supported by omega-stringers 22 or other rods or supporting structures. The omega-stringers 22 in particular have an orientation parallel to the longitudinal axis y of wing 2. The supporting region 14 may in this case be formed by a sliding contact between the outer surface 16 of the supporting elements 11 and inner sliding surfaces of the omega-stringers 22.

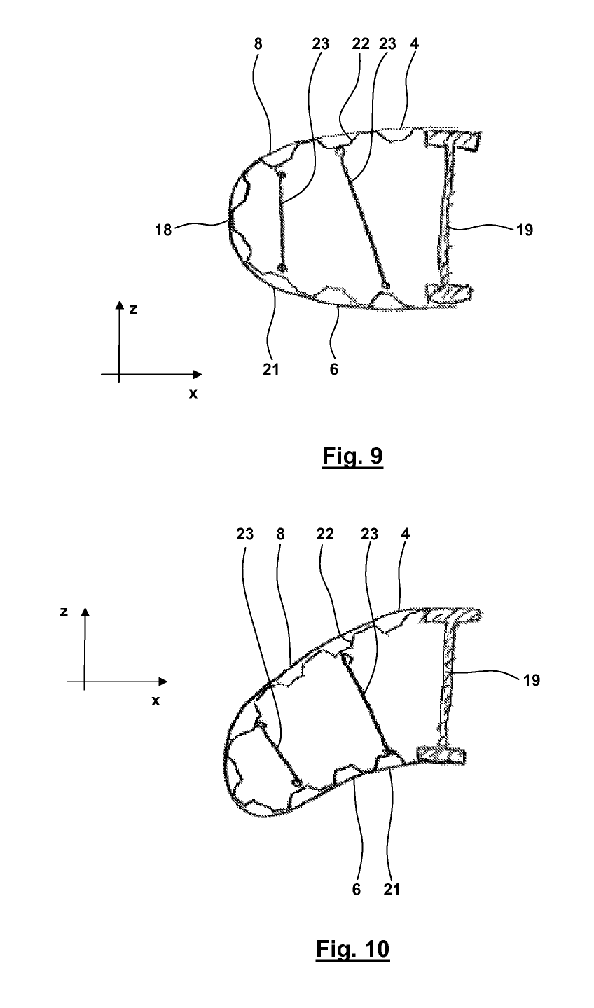

For the embodiment shown in FIG. 4, the interval between adjacent supporting elements 11 is hollow without any additional supporting elements. For this embodiment, the outer shell 8 is equipped with sufficient mechanical stiffness such that there are no distortions of the outer shell 8 between adjacent supporting elements 11 caused by the mechanical and aerodynamic loads. In particular, in case of using a soft outer shell 8 and/or for increasing the distance of the supporting elements 11 in longitudinal direction of the wing 2 in order to reduce the overall weight, an embodiment as shown in FIGS. 9 and 10 may be used. Here, additional supporting elements 23 are located in the interval between adjacent rotatable supporting elements 11. The additional supporting elements 23 are used for avoiding distortions of the outer shell 8 and for guaranteeing that the contour of the wing 2 between the adjacent rotatable supporting elements 11 corresponds to a predetermined contour (which is dependent on the rotation of the supporting elements 11). For the embodiment shown in FIGS. 9 and 10, the additional supporting elements 23 are formed by pendulum rods extending between the upper surface 4 and lower surface 6. The pendulum rods are pivotably linked in their end regions with the omega-stringers 22. The additional supporting elements 23 are not used for influencing the contour with the rotation of the supporting elements 11 but guarantee a predetermined contour between the adjacent supporting elements 11. However, any other type of additional supporting elements 23 differing from the shown pendulum rods 23 may also be used.

For establishing a sliding contact between the supporting elements 11 and the outer shell 8, known measures might be used. In particular, the omega-stringers 22 and/or the outer surface 16 may be coated with an anti-frictional material.

The present invention provides an outer shell 8 with a variable contour 3, 5. The contours 3, 5 are varied without the need of slots or undesired edges in or at the outer surfaces. By a rotation of the supporting element 11 for one embodiment the leading edge of a wing may be lowered or lifted during the starting and landing process. For this aim, the outer shell 8 is in particular constructed from a fiber composite material that has the capability of being reversibly deformed by a rotation of the supporting elements. At the same time, the fiber composite material guarantees a sufficient form stability in intervals of the wing 2 without any support by supporting elements 11, 23. Deformation forces might be transferred to the outer shell 8 over the entire profile in a cross-section. With the use of omega-stringers 22 the force transfer to the outer shell 8 is improved. It is also possible that in one and the same wing 2, a plurality of supporting elements 11 with same or different outer contours, in particular differing curvatures of the longitudinal axes 17 and/or differing diameters of the outer surfaces and deviations from a circular cross-section may be used.

It is also possible that the rotatable supporting elements 11 are balanced with respect to their masses so that the center of gravity of the supporting elements with the mass balancing does not shift with a rotation of the supporting elements 11.

The outer shell 8 comprises deformation regions. These deformation regions are elastically or plastically deformed by the deformation forces. These deformation regions are in particular located upstream or downstream from the supporting regions or are located in the transverse cross section in front or behind the supporting region when seen in streaming direction of the airflow floating around the contour.

Many variations and modifications may be made to the preferred embodiments of the invention without departing substantially from the spirit and principles of the invention. All such modifications and variations are intended to be included herein within the scope of the present invention, as defined by the following claims.

We claim:

1. An aerodynamic component comprising
an outer shell,
at least one supporting element supporting said outer shell,
a drive unit in drive connection with said supporting element for rotating said supporting element,
a supporting region built between said supporting element and said outer shell for transferring deformation forces from said supporting element to said outer shell,
said supporting element being designed and configured for changing the distance of said supporting region from a longitudinal plane of said aerodynamic component with a rotation of said supporting element by said drive unit and
said outer shell comprising an elastic deformation region, said elastic deformation region being elastically deformed by said deformation forces with a change of the distance of said supporting region from said longitudinal plane caused by a rotation of said supporting element.

2. The aerodynamic component of claim 1, wherein said supporting element has an axis of rotation parallel to the airflow interacting with said aerodynamic component.

3. The aerodynamic component of claim 1, configured and designed such that with a rotation of said supporting element said supporting region moves along an inner surface of said outer shell.

4. The aerodynamic component of claim 1, wherein said supporting element comprises a curved contact surface and said aerodynamic component is designed and configured such that with a rotation of said supporting element said supporting region moves along said curved contact surface of said supporting element.

5. The aerodynamic component of claim 1, wherein said supporting element contacts an upper outer shell of said aerodynamic component in a first supporting region and contacts a lower outer shell of said aerodynamic component at a second supporting region.

6. The aerodynamic component of claim 4, wherein said supporting element comprises an outer surface being closed in circumferential direction around the axis of rotation of said supporting element.

7. The aerodynamic component of claim 6, wherein said outer surface of said supporting element comprises an extension parallel to the axis of rotation of said supporting element.

8. The aerodynamic component of claim 7, wherein said outer surface of said supporting element in the direction of the axis of rotation comprises a contour correlating or equaling the outer contour of the upper outer shell or the lower outer shell of said aerodynamic component.

9. The aerodynamic component of claim 4, wherein said outer surface of said supporting element in a cross-section taken transverse to the axis of rotation comprises a cam-like outer contour.

10. The aerodynamic component of claim 1, comprising a plurality of rotatable supporting elements, said plurality of supporting elements being located at different positions along the longitudinal axis of said aerodynamic component.

11. The aerodynamic component of claim 10, wherein between adjacent supporting elements further supporting elements support said outer shell and said further supporting elements are designed and configured for permitting a deformation of said outer shell also between said adjacent supporting elements.

12. The aerodynamic component of claim 1, wherein said outer shell is supported by inner stringers, said stringers contacting said rotatable supporting element with at least one contact point.

13. The aerodynamic component of claim 1, wherein said drive unit and said at least one supporting element are located between a frontspar and a leading edge of said aerodynamic component and said drive unit is mounted with said frontspar.

14. The aerodynamic component of claim 1, wherein said supporting region is created by a sliding contact between said rotatable supporting element and said outer shell.

15. The aerodynamic component of claim 1, wherein said supporting element comprises a curved longitudinal axis.
